(19) United States
(12) Patent Application Publication
(10) Pub. No.: US 2014/0278951 A1
(43) Pub. Date: Sep. 18, 2014

(54) SYSTEM AND METHOD FOR IDENTIFYING AND ENGAGING COLLABORATION OPPORTUNITIES

(71) Applicant: AVAYA INC., Basking Ridge, NJ (US)

(72) Inventors: Neil O'Connor, Galway (IE); Tony McCormack, Galway (IE); Paul D'Arcy, Limerick (IE)

(73) Assignee: AVAYA INC., Basking Ridge, NJ (US)

(21) Appl. No.: 13/832,112

(22) Filed: Mar. 15, 2013

(51) Int. Cl. G06Q 30/02

(52) U.S. Cl. CPC G06Q 30/0251
USPC 705/14.49

(57) ABSTRACT

A business development system for an enterprise is provided. The business development system includes a target searching module that seeks and engages a potential target in a promotional activity for gaining reward points. The business development system further includes a strategy determining module that analyzes circumstances for determining a suitable persona and interaction strategy for engaging the potential target. The business development system further includes a strategy executing module that interactively engages with the potential target by applying the determined persona and strategy for engaging the potential target into the promotional activity. Additionally, the business development system includes a strategy sharing module that stores information related to interaction with the potential target in an experience database.

### BACKGROUND

1. Field of the Invention

Embodiments of the present invention provide a system and a method for assisting an enterprise in growing business opportunities. More particularly, embodiments of the present invention provide a system and a method for identifying and engaging new business opportunities.

2. Description of Related Art

Ever since the world got connected via the World Wide Web, a tremendous growth in count of web users is noticed. This attracted a lot of advertising agencies, as they got another dimension for promoting and selling their goods and services. However, as more content providers appear on the web, it becomes more and more difficult for the web users to identify and locate specific/desired information, which is available over the Internet. Thus, a race began for the online merchants to harness the potential of e-commerce by efficiently organizing and distributing their marketing information over the Internet.

Overall, e-commerce became a large and important segment of the economy. In fact, e-commerce has developed to the extent that virtually any good or service is available online, even from multiple sources (online merchants). Moreover, with the increase in the count of the online merchants, the web users got flooded with a lot of marketing information and promotional offers. Therefore, it became very difficult for the online merchants to allure customers. This invited a neck to neck competition between the online merchants. Hence, the online merchants started seeking new ways to expand their addressable market for engaging with new customer opportunities.

Generally, for the purpose of expanding online business, the online merchants either hire contact centers or similar agencies for developing their business or take the benefit of the state of the art technologies to target bigger market opportunities. However, hiring such agencies or making use of the state of the art technologies requires a lot of resources and a large investment. In addition, such processes demand maintenance cost. For example, if an enterprise needs to target a long list of people over the age 55, living in Orange County (Florida), who have reasonably been notified that they are going to renew their health insurance, and who shop quite often in a particular shopping mart, then the enterprise may need to hire sizable human staffing to make calls to such people for selling them the health insurance policy. This is a long task that demands massive investment, which is difficult and expensive to scale and setup.

Therefore, there is a need for a scalable system and method that is economical as well as capable of assisting the online merchants in identifying and engaging new business opportunities.

### SUMMARY

Embodiments in accordance with the present invention provide a business development system for an enterprise. The business development system includes a target searching module for searching and selecting a target entity from a target list. The target list may be provided by an agent of the enterprise. Further, the target searching module may use a pattern matching algorithm to select a suitable target entity. The business development system further includes a strategy determining module for determining a strategy to engage the target entity selected by the target searching module into a promotional activity corresponding to the enterprise. Further, the business development system includes a strategy executing module for executing the strategy determined by the strategy determining module on the target entity selected by the target searching module. This may engage the target entity into the promotional activity corresponding to the enterprise. Furthermore, the business development system includes a strategy sharing module for sharing the strategy and results of the strategy execution by the strategy executing module in an experience database that is shared with at least one web robot.

Embodiments in accordance with the present invention further provide a computer-implemented method for engaging a potential target to discover opportunities of market expansion for an enterprise. The computer-implemented method includes searching a potential target from a target list, determining and applying a strategy for engaging the potential target into promotional activity corresponding to the enterprise, and sharing the strategy and its results in a Neural Network of web robots.

Embodiments in accordance with the present invention further provide a computer readable medium storing computer readable instructions when executed by a processor performs a method. The method includes searching a potential target from a target list, determining and applying a strategy for engaging the potential target into a promotional activity corresponding to the enterprise, and sharing the strategy and its results in a Neural Network of web robots.

Further, the present invention can provide a number of advantages depending on its particular configuration. Embodiments of the present invention provide a system and a method for an easily scalable, neurally programmed automaton bot that is designed to identify targets with which collaboration sessions are established. Further, the proposed automaton/bot has the capability to select experiences and personas for maximizing value generation, and to share outcomes with other similar automatons for creating a self learning Neural Network that is capable of learning from its failures. The proposed system has the capability of ever improving Neural Network that is easy to scale.

Furthermore, the present invention goes beyond the state of the art technologies of web crawling and tailored advertisements to introduce a disruptive technology that identify and further engage a potential target in conversation by using NLP engine for creating business opportunities for an enterprise. The present invention is also capable of connecting a potential target directly with a skilled agent by using WebRTC protocols.

These and other advantages will be apparent from the disclosure of the present invention contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1A illustrates an environment, where various embodiments of the present invention may be implemented;

FIG. 1B is an exemplary block diagram of a system that supports a contact center in developing business opportunities for an enterprise, in accordance with an embodiment of the present invention;

FIG. 2 is an architecture that is used to enable an agent of the contact center to communicate with a targeted entity by using WebRTC technology, in accordance connection with an embodiment of the present invention; and

FIGS. 3A and 3B illustrate a method for engaging a potential target into a promotional activity, in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

The present invention will be illustrated below in conjunction with an exemplary communication system, e.g., the Avaya Aura® system. Although well suited for use with, e.g., a system having an ACD or other similar contact processing switch, the present invention is not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

FIG. 1A illustrates an exemplary environment 100 where various embodiments of the present invention are implemented. The environment 100 includes a contact center 102 that is in communication with a target list 104 via a network 106. The network 106 may include, but is not restricted to, a communication network such as Internet, PSTN, Local Area Network (LAN), Wide Area Network (WAN), Metropolitan Area Network (MAN), and so forth. In an embodiment, the network 106 can be a data network such as the Internet.

Further, the target list 104 may include various online services that usually get a lot of human visitors. Such human visitors can be targeted by the contact centers or similar assisting agencies of an enterprise who are seeking to grow their market scope over the web in search for business collaboration opportunities. The online services may include but are not limited to, social networking services 104a, online gaming services 104b, blog services 104c, and chatting or conferencing services 104n.

Further, as shown in FIG. 1A, the contact center 102 further includes a server 107 comprising a plurality of web robots (shown as bots 108a-n). The web robots (hereinafter, may be referred to as ‘bots’ or ‘bot’) are also known as Internet bots. Each bot from the plurality of bots 108a-n (hereinafter, referred to as ‘plurality of bots 108’) is a piece/module of programmed instructions that can be stored in a database (not shown) of contact center's server 107. Further, each bot is configured to be autonomous. In an embodiment, a bot is built by combining functionalities of a WebRTC-enabled browser, a Neural Network (NN), a simple JavaScript B2B, and a web crawler.

Further, in an exemplary embodiment of the present invention, the plurality of bots 108 are configured to form a Neural Network (not shown) for receiving, interpreting, and sharing information. Further, the plurality of bots 108 use an experience database, such as experience database 110 for storing traversed/learned/experienced information. Furthermore, the plurality of bots 108 may be configured to use artificial intelligence for helping each other in the Neural Network by sharing their experiences.

In an embodiment, the experience database 110 may be a sub-database of the aforementioned database of the contact center. Further, the experience database 110 may be used by the plurality of bots 108 to learn from experiences of other bots (as every bot stores its experience in the experience database 110). In an embodiment, the bots may have their own memory and may have communication means to transfer memory data directly to other bots).

In an embodiment, based on experience, a bot may provide suggestions to other bots. For example, if a bot has succeeded in a task ‘X’ by following a strategy ‘Y’, and the bot notices that another bot needs to execute the same task, then the bot may suggest the strategy ‘Y’ to the another bot as a successful strategy for the task ‘X’. In an embodiment, the strategy ‘Y’ may be saved by the bot in the experience database 110 for task ‘X’, and other bots may search the experience database 110 before executing any task.

Further, in an embodiment, an agent of the contact center may have authority to program or instruct the plurality of bots 108 (or a single bot) to perform an action. The agent may also provide certain information or guidelines to the plurality of bots 108 for performing the action. In an embodiment, the information may include a target list, such as target list 104. Further, in an embodiment, the contact center 102 may use WebRTC technology for enabling the plurality of bots 108 to communicate with the target list 104. WebRTC is an open source technology that enables web browsers with Real-Time Communications (RTC) capabilities via simple JavaScript APIs.

As shown in FIG. 1A, the agent of the contact center may use an interface, such as Web API 112 (web application programming interface) that is using a WebRTC layer 114 for implementation of proposals (instructions) for the plurality of bots 108. Based on the proposals, the plurality of bots 108 may perform required tasks. In an exemplary embodiment of the present invention, the plurality of bots 108 may be configured in a way that they only perform tasks to gain reward points, i.e., if the bots are offered reward points to do a task, only then they will perform the task, otherwise not. Further, the plurality of bots 108 may also be configured to give priority to a task that will provide higher amount of reward points comparative to other tasks (if available).

In real-world, the reward points may not be of any use to the bots. However, in virtual world, the reward points may function as a trigger for the bots to perform an action. In another embodiment, the reward points may help the bots to learn from other bots (who have earned some reward points) and may also enable the agents of the contact center to determine efficiency of each bot from total reward points earned by the each bot.

For example, in case, if all bots have same programming code, then the reward points may help the bots, themselves, to determine a strategy to perform a task, based on rewards points earned by the other bots in the same task, i.e., if hundred bots are deployed to perform task A (by forming a Neural Network), then one out of the hundred bots may query from the Neural Network or in the experience database 110, to determine a bot which has already earned maximum number of reward points in comparison to other 99 bots in the Neural Network. Thereafter, the bot may copy the strategy followed by the highly rewarded bot for performing the task A.

This learning when followed by each bot in the Neural Network will continuously and consistently enhance skills of all the bots. Hence, after a period of time, the Neural Network of the hundred bots will be skilled enough to crack the task A in almost every try. In other case, if all bots do not share common programming code, then a bot that earns highest rewards points among other bots, may be considered to have an efficient program code. This may help a bot programmer to improve program code of other bots.

In an exemplary embodiment, a contact center may need to target a specific filtered list of potential contacts, or potential customers, or potential targets for a particular company. In an embodiment, potential targets may be human as well as non-human entities. For example, a contact center may work for footwear manufacturing/selling company, and may have an objective of targeting all those human game players those visits a particular footwear retailing shop (say shop X, that may be a shop of rival organization) in an online game of virtual world, such as a video game that is a replica of real world. Therefore, the contact center may trigger the plurality of bots 108 by enabling them to interact/query with supporting libraries of the online game (such as APR for apache web server) for earning rewards points. In an embodiment, the bots may earn reward points if they are successful in connecting any human game player with the IVR system of the contact center.

The plurality of bots 108 may start querying the supporting libraries of online game by a number of pre-set questions. Each bot may query the supporting libraries and may share the results with other bots of its Neural Network. In this manner, the plurality of bots 108 may gather significant information about the game and its game players. For example, the plurality of bots 108 may be able to find out that there's an Avatar (of a human game player) named ‘A’, and an Avatar named B in the online game who are visiting the shop ‘X’ in the online video game's virtual world. Then, the plurality of bots 108 may retrieve contact information of the Avatars ‘A’ and ‘B’ from the supporting libraries of the online game and at least one bot from the plurality of bots 108 may establish a direct communication with their browsers.

The communication may be a web chat, voice call, video call etc. Thereafter, the bot may provide details corresponding to live promotional offers related to a footwear manufacturing/selling company (who deployed the plurality of bots). Further, the bot may either lead the users (with avatars) to a web link from where they can purchase foot wear, or the bot may connect the users with IVR system of the contact center (or may be directly to an agent from the contact center). After accomplishing this, the bot may receive pre-set rewards points.

In another example, a contact center may deploy the plurality of bots 108 to the online game for targeting players of the game. The plurality of bots 108 may then determine that out of all game players, one game player is online on a social networking website. Thereafter, the plurality of bots 108 may scan postings from the user on the social networking website and may determine if any of a product from its deploying organization matches with any of the postings from the user. On match of a product or service, the at least one bot from the army of the bots 108 may contact the user, either by sending an instant message or audio/video call. Additionally, the bot may play a video that advertises a product.

In the case of audio/video call, the bot may send an audio/video call request in back end to an agent, and then may bridge the call between the agent and user. This way the bot earns pre-set reward points. In an embodiment, the bot may use its Neural Network to decide if the user is a good target or not, and after succeeding, the bot may share the result with other bots in its Neural Network.

In an embodiment, if a bot earns a reward point, then the bot may share its success strategy, which can be followed by other bots in the Neural Network. In another embodiment, if a bot fails to earn or takes more than a pre-set time earn reward points, then other bots may learn from this failure and may try other targets or other strategies. Further, in an embodiment, there may be a cost to the bot for engaging a human resource in an interaction, which may weight up against likelihood of a positive outcome. In an embodiment, positive outcome may refer to a purchase.

In an embodiment, a bot may select its target based on pattern matching neural programming (hereinafter, interchangeably referred to as “pattern matching algorithm”). The bots may specify any target and a set of inputs/strategies that the bot is going to test on target, and the pattern matching algorithm may inform the bot that whether or not the bot will receive any rewards with such target or strategy. In an embodiment, the may copy a successful strategy of other bot and may just change certain inputs/characteristics and may determine from the pattern matching algorithm that the expected amount of rewards points. Further, based on the amount of expected rewards points, a bot may decide whether or not to pursue the target.

In addition, a contact center may target more than one target area by using the plurality of bots 108. The contact center may deploy the bots simultaneously on social networks, other popular sites, blogs etc. The contact center may also allocate bots for a specific domain, e.g., 100 bots for social network websites, 50 bots for a blog website etc. In addition, the contact center may provide the bots with metadata words for which the bots need to accumulate data and based on which the bots are required to perform a task. For example, if a plurality of bots are instructed to post a video on slavery on a blog site if the bot notices any related material, such as labor, bad practice etc. The bots may receive rewards points if a user watches the full video without stopping it.

In an exemplary embodiment, broadly, the bots may be programmed to pick a target from any web service and may analyze that a female user is browsing for ‘X’, ‘Y’ and ‘Z’, and she is watching an online video of a car, and that where the bot may decide to show an promotional video of a car, for which there is a high probability that the female user will watch that video. In addition, the bot may also establish a bridge of video call by using WebRTC technology between the female user and an agent from contact center, regarding car purchase or related queries.

Further, in an exemplary embodiment of the present invention, all bots include a system program, such as business development system 116 (as shown in FIG. 1B) that enable the bots to perform required actions. Specifically, the business development system 116 enables the plurality of bots 108 to identify, approach, interact, and allure web surfers (or online human users) to purchase any product or service of the enterprise who deployed the plurality of bots 108. Further, the business development system 116 enables the plurality of bots 108 to function as a Neural Network and to build an experience database (database 110) for storing information corresponding to all executed activities/tasks that resulted either in success or failure. This enables the bots to learn from the success and failures of other bots and results in improved performance of the plurality of bots 108. Detailed configuration and description of the business development system 116 is provided further in FIG. 1B of the present invention.

FIG. 1B is an exemplary block diagram of a system, such as business development system 116 that supports the contact center 102 in developing business opportunities for an enterprise. As shown, the business development system 116 is a part of the bot (108a, as shown in FIG. 1A), and the bot 1 may be stored in a database (not shown) of the contact center 102. It will be appreciated by a person skilled in the art that the business development system 116 is not just a part of bot 1, however, each bot of the plurality of bots 108 possesses the business development system 116, and FIG. 1B illustrates a single bot with the business development system 116 for better understanding of the present invention.

In an embodiment, the business development system 116 can be equipped with Semantic Web technology to assist in the more accurate discovery of suitable targets. Semantic Web technology also provides the means for more meaningful interaction between the bot and its target, as Semantic Web provides information about meaning of the data that is made available through computing API.

Further, as shown, the business development system 116 may include various modules, such as but not limited to, target searching module 118, strategy determining module 120, strategy executing module 122, and strategy sharing module 124. The target searching module 118 is configured to receive target list. The target list may be provided by an agent of a contact center or by any representative of an organization/enterprise that is deploying bots on the target. The target list may include data that informs the bot 108a about a task that is required to be performed on a particular target.

A target may be any social website, blog, gaming servers, etc. Further, the target list includes a connecting link that enables the bot 108a to access supporting libraries of the target. The supporting libraries of any system are configured to store all available data corresponding to the system. For example, the target searching module 118 may receive an instruction to search for all human players that are connected with a particular gaming server and to insist them to talk to customer executives of a company that creates/sells gaming disks.

Further, the target searching module 118 is configured to receive reward information. The reward information may also be received from any representative of the organization that is deploying the bots on the target. The reward information may include certain instructions that are required to be followed during the task for achieving reward points. For example, the target searching module 118 may receive information that if a human player connects with an IVR system of the company then the bot 108a will receive 10 points, and if the player talked at least 5 minutes with an agent of the company then the bot 108a will receive a total of 20 extra points.

Further, if the player placed any purchase order, then the bot 108a will receive a total of 30 points. Additionally, the target searching module 118 is configured to search for a target entity within/from the received target. For example, if a target is a social network website, then target entity will be any user of the social network website.

Furthermore, the target searching module 118 is configured to use a pattern matching algorithm for determining whether or not to pursue a searched target entity. In an embodiment, the pattern matching algorithm may provide information to the target searching module 118 corresponding to amount of points that can be earned from a particular target entity. For example, if there is a reward of 10 points in connecting an avatar of a boy within age of 1-9 years to IVR system, and a reward of 50 points in connecting an avatar of a boy of age 10-20 years, a reward of 100 points for boys above age of 20 years, and a reward of 20 points in connecting any girl of any age with the IVR system. Then, whenever the bot 108a encounters at least two avatars of humans, then the target searching module 118 used the pattern matching algorithm to select an avatar that may provide more rewards points i.e., a boy over age of 21 years will be a better choice than a boy of 18 years.

The strategy determining module 120 is configured to receive information corresponding to a selected (selected by the target searching module 118) target entity that may generate maximum reward points for the bot 108a. Further, the strategy determining module 120 may be configured to engage the selected target entity into a promotional activity corresponding to the enterprise. The promotional activity may include any activity, such as but not restricted to, providing advertisements, promotional offers, providing information, using damage limitation techniques, or raising awareness for a particular subject, such as, topic, product, political party, or organization that can improve either business or goodwill of the enterprise. The goodwill of the enterprise may include, but is not limited to, brand value, reputation, and trustworthiness.

Further, based on the searched/selected target entity, the strategy determining module 120 may analyze circumstances and situation for determining an attractive persona/avatar. In an exemplary embodiment of the present invention, the strategy determining module 120 may use pattern matching neural programming to select personas, self service experiences, locales, languages, and dialects for enhancing the strategy to optimize chance of success. In addition, the strategy determining module 120 may check experience database 110 to search if there is a persona saved that has already resulted in reward points for the same/similar target entity.

If such persona found, then the strategy determining module 120 may prefer to choose the tested persona. For example, if the target searching module 118 selected a lady of 40 years for connecting to the IVR system, then the strategy determining module 120 may also choose a persona of 40 year old lady wearing clothes of a sales woman to ensure the target entity feel comfortable in talking with persona of the bot 108a. On the other hand, if the target searching module 118 selected a boy of 25 years for connecting to the IVR system, then the strategy determining module 120 may choose a persona of a girl of 20-30 years wearing clothes of a sales girl to ensure the target entity feels interested in talking with persona of the bot 108a. Similarly, if the target searching module 118 selected a boy of 9 years for connecting to the IVR system, then the strategy determining module 120 may also choose a persona of 9 years old boy wearing cloths of a video game character (which is to be promoted for sale) to ensure the target entity feels excited in talking with persona of the bot 108a.

In addition, the strategy determining module 120 is configured to determine a strategy to initiate interaction with the selected target entity by using the selected persona to ensure that the bot 108a receives reward points. In addition, the strategy determining module 120 may check experience database 110 to search if there is a strategy saved that has already resulted in reward points for the same/similar target entity.

If a strategy is found, then the strategy determining module 120 may prefer to choose the saved strategy. For example, if a persona of a 40 year old lady wearing clothes of a sales woman is selected, then the strategy determining module 120 may choose to say “Hi, I see you having a good time playing this game. Even I used to love playing this game with my son. Do you know that a sequel of this game released last week? Here is a web link for a video trailer of its sequel. Check it out.”

If a persona of a girl of 20-30 years wearing clothes of a sales girl is selected, then the strategy determining module 120 may choose to say “Hi there, this game is out is the trend now, check out screen shots of this new game. Everyone is moving on to this new game as it is loaded with a lot of new stuff. Check this out!” Further, if a persona of 9 years old boy wearing cloths of a video game character is selected, then the strategy determining module 120 may choose to say “Hi, I am playing this new super cool game. I need more friends to play with me. If you want to play with me, then download this game by clicking on this blue link.”

The strategy executing module 122 is configured to receive information corresponding to the selected persona and selected strategy from the strategy determining module 120, for engaging collaboration opportunities with the target entity. The strategy executing module 122 executes the strategy selected by the strategy determining module 120. Further, the strategy executing module 122 is configured to receive replies from the target entity. Furthermore, the strategy executing module 122 is configured to interpret the replies of the target entity and to provide suitable replies to the target entity.

In an embodiment, the strategy executing module 122 may use a NLP engine to interpret voice replies of the target entity. Further, the strategy executing module 122 may depend on pre-set replies or on its experience database to select a suitable reply for the target entity. Moreover, the strategy executing module 122 is configured to reply to the target entity only in a condition when it is sure about accuracy of the reply. Otherwise, if the strategy executing module 122 interprets that the reply of the target entity cannot be interpreted, or the target entity is showing frustration, or target entity is demanding to talk to an agent, then the strategy executing module 122 may initiate an audio/video with the target entity, and in backend may initiate a session with an agent, and may then join the sessions to enable the target entity to be handled by agent of the contact center by using WebRTC browser to browser real time communication technology.

The strategy sharing module 124 is configured to determine if the strategy applied by the strategy executing module 122 resulted in gain of rewards points or not i.e., the task was successful or failure. Further, the strategy sharing module 124 is configured to update the experience database 110 that is shared by the Neural Network of the plurality of bots 108. The strategy sharing module 124 may update the experience database 110 with information that whether a strategy for a target entity earned reward points or not. For example, if the strategy of engaging a 40 year old lady with the IVR system did not received success, then the strategy sharing module 124 may put this information in the experience database that engaging a 40 year old lady by another 40 year old lady with pickup line xyz did not resulted in reward points. This may encourage the strategy determining module of other bots in the Neural Network to try some new strategy for a 40 year old lady game player. On the other hand, if the strategy would have resulted in rewards points, then the strategy determining module of other bots in the Neural Network will always prefer to try the same strategy for the 40 year old lady game player.

In this manner, the business development system of the bots ensures the Neural Network of the bots keeps learning from their mistakes and keeps trying successful strategies. This will make the Neural Network of the bots a self learning network whose performance will keep on increasing with time. In an embodiment, such learnt experience can be initially served to new/other plurality of bots (by sharing the experience database) to ensure they always start learning from an already achieved milestone. Further, in an embodiment of the present invention, the strategy sharing module 124 may be configured to directly share learnt information with other bots in the Neural Network.

FIG. 2 depicts an architecture 200 that is used to enable an agent of the contact center 102 to communicate with a targeted entity by using WebRTC technology. As shown, web browser 202 of an agent (hereinafter may be referred to as ‘agent's browser’ 202) of the contact center 102 (not shown in FIG. 2) is in communication with another web browser 204 of a customer (hereinafter may be referred to as ‘customer's browser’ 204) via the network 106. In an embodiment, the agent's browser 202 and the customer's browser 204 may be any web browser that supports the WebRTC technology. Further, the agent and the customer must have a device that supports WebRTC enabled browsers. Examples of such device may include, but are not restricted to, a personal computer, a mobile phone, a smart phone, a personal digital assistant (PDA), a tablet computer, a laptop, and the like.

Further, the agent's browser 202 may be enabled to communicate with the customer's browser 204 over the network 106 by the WebRTC layer 114 with the help of web API 112. Further, the WebRTC layer 114 includes WebRTC Native API layer 206, which is used for peer connections and helps in implementation of the proposals received from the web API 112. Further, the WebRTC layer 114 includes a session manager layer 208, which is used to enable real time protocols for establishing and managing connections across the network 106.

The WebRTC layer 114 includes three types of frameworks such as, voice engine framework 210, video engine framework 212, and transport framework 214. The voice engine framework 210 is used for the audio media chain, from sound card to the network 106. It also helps in cancelling acoustic echo and in reduction of noise. The voice engine framework 210 further includes an optional audio capture API 216 for recording audio communications.

Further, the video engine framework 212 is used for the video media chain, from camera of the device (not shown) having the agent's browser 202 to the network 106 and from the network 106 to display screen (not shown) of the device. It also helps in helps in concealing effects of video jitter and packet loss on overall video quality. Moreover, it also removes video noise from images captured by the camera. The video engine framework 212 further includes an optional video capture API 218 for recording video communications.

In addition, the transport framework 214 is used in peer to peer communication and its optional network I/O API 220 may facilitate management of inputs/outputs of the agent or customer over the network 106. This WebRTC architecture enables the agent's browser 202 to communicate with the customer's browser 204. In an embodiment, the customer's browser 204 may have a similar architecture as of the agent's browser 202.

In an embodiment, a web robot, such as bot 108a may be configured to send a request to the contact center 102 for requesting an agent to communicate with the targeted entity. The agent may receive contact details for contacting with the customer via the bot 108a. The agent may then be able to create an audio/video session with the targeted entity by using WebRTC enabled browsers. In an embodiment, a bot may be configured to engage a target customer in an autonomous manner. However, based on certain conditions, such as if a target is of high value, or if target is showing frustrations, then the bot may decide not to pursue the target further and may connect the target with an agent. In this manner, a bot performs business development activities for an enterprise in an autonomous manner. Neural Network of such bots creates a very fast, efficient, and economical way of business development for any enterprise over Internet. Furthermore, scaling up of such bots is an easy process as adding bots is equivalent to creating little more than another browser instance. Scaling up is supported by the fact that there is no central media server streaming the media, as it comes from the WebRTC layer.

FIGS. 3A and 3B illustrate a method for engaging a potential target entity into a promotional activity corresponding to an enterprise. At step 302, an agent of a contact center deploys at least one bot (web robot) over Internet for discovering opportunities of market expansion for the enterprise with a target list. The bot is built by combining functionality of a WebRTC-enabled browser, a Neural Network (NN), a simple JavaScript application, and crawling capability (or web crawler). The target list may include a digital virtual world, social media system, online gaming system, chatting system, public telephone system, or even Internet.

Further, the bot may be pre-programmed to receive reward points after engaging the target entity into a promotional activity, such as by facilitating a human user to purchase a product or service. Furthermore, a bot is configured to seek out opportunities to enhance its reward system. The bot accumulates reward when it finds and connects a target, which can be a human user and can be a computing entity, with one or more of a specified list of applications. The specified applications could be self-assisted/self-service applications, customer relationship management (CRM) systems, or other applications that generate value for the enterprise that is deploying the bots.

At step 304, the bot may start searching for a potential target within the target list. In an embodiment, the potential target may be any human web user who satisfies certain conditions. The conditions may be received with the target list. For example, the conditions may include, but are not limited to, human user below the age of 50, female users, or users that are searching for a mobile phone. In an embodiment, a bot can be directed to investigate a digital virtual world, social media system, public telephone system, internal chatting system of an enterprise, or even the Internet, in general. Further, enhanced meta-data of exposed services that are a superset of well-established WSDL-like technologies (e.g., DAML-S), can be used by the bot to autonomously discover how to interact to a target system/entity. It has the capability of assuming an identity based on pattern matching neural programming, which it selects if it determines that it may enhance reward opportunities.

Further, at step 306, if the bot determines a potential target then the method proceeds forward to step 308, otherwise the method starts again from step 304. In an embodiment, semantic web technology is used to assist in more accurate discovery of suitable targets. Further, the aforementioned steps may be performed by the target searching module 118.

At step 308, the bot selects a suitable persona to engage the potential target from a library of self service experiences. The library may include a list of persona that has already been tried other targets. Based on previous success or failure of the personas, the bot selects a suitable persona. In case, if the bot do not find any history data, then the bot may copy persona according to the circumstance. For example, if the targeted entity is a male of age 20, then the bot may choose a persona of a girl of age 20.

At step 310, the bot selects a suitable strategy to engage the potential target from a library of self service experiences. The library may include a list of strategies that have already been tried on other targets. Based on previous success or failure of the strategies, the bot selects a suitable strategy. In case, if the bot do not find any history data, then the bot may choose a suitable promotional activity for the potential target to engage the target into the promotional activity, such as for purchase of a product or service. For example, if the potential target is searching for video reviews of the mobile phone, then the bot may provide a web link (via WebRTC communication) of a promotional video of mobile phone of its deploying enterprise. In an embodiment, the steps 308 and 310 may be performed by the strategy determining module 120.

At step 312, the bot may reply back with some text or may establish a voice call, then the bot may use NLP engine to interpret the reply. Further, at step 314, if the bot determines if the reply of the potential target satisfies certain pre-set conditions, such as but not limited to, reply cannot be interpreted, reply shows frustration of the target, reply includes unknown query, reply shows target want to talk to agent, etc. If the reply does not satisfy the conditions, then the method proceeds to step 316, otherwise to step 318.

In an exemplary embodiment of the present invention, reward system of the bot is driven by its neural programming. The bot attaches to the target system (for example the query-able APIs exposed by a social media or blog service), and uses discovered values as some of inputs for its Neural Network (NN). Further, the bot may add other input values by testing candidate values from its library of identities, library of self service experiences (i.e., experience database 110), NLP suggestions or other useful inputs. For each combination of inputs (some detected from the target system, and some selectable by the bot) the NN may calculate an output set/pattern. Many theoretical combinations can be tested in a short time. Some of the inputs may generate an output pattern that may represent a value, which shows the current set of inputs work well together. Furthermore, the bot may use a set of inputs over which it has control, and may initiate collaboration with the target, leveraging its WebRTC media ability.

At step 316, the bot replies suitably (in its autonomous mode) to the potential target and may provide a web link to the potential target to purchase the mobile phone. On the other hand, at step 318, the bot informs an agent from the contact center to establish a call with the potential target to engage the target for purchasing the mobile phone. In an embodiment, the steps 312-318 may be performed by the strategy executing module 122.

Further, in an embodiment, WebRTC-facilitated self-service audio experience that may be selected based on weighted chance for success may be answered and the bot may use its B2B to refer this session onwards to a contact center application for further reward. That is to say, based on a set of conditions (e.g., high value target, frustration being expressed by target), the bot may attach a real agent. This may make the bot-like functionality much more acceptable from a consumer perspective. The bot can also decide to move back to full autonomous mode (as in step 316).

Thereafter, at step 320, the bot stores its experience of dealing with the potential target in the library of self service experiences for teaching other bots. In an embodiment, the NN can use techniques known in the art such “back-propagation” to learn which input patterns generate reward, and share such information with the other bots. Thereby, the bots collaborate indirectly to build a common repository of neural patterns that can be shared amongst the bots.

For example, the bot may store information that, by using a persona of a girl of 20 years and by showing a video XYZ of mobile ABC, the male customer of 20 years purchased the mobile without contacting with the contact center. This may teach other bots to perform the same strategy for 15-25 year old boys searching videos of mobile phones. In an embodiment, the step 320 may be performed by the strategy sharing module 124.

In an exemplary embodiment of the present invention, input patterns for the bots can be arbitrarily complex, according to the available features of the target system. For example, if the target system is a Virtual World, then input parameters could be: time of day, location, services on offer, avatar persona types in vicinity, sentiment of previous 10 minutes of avatar interactions, etc. Further, the bot consumes such inputs, and iterates further input values with its available personas and experiences. Also, for each combination an output, a pattern is generated. For example, if a bot finds a NN reward pattern output results only in a case where it assumes persona of a female motorcycle brand enthusiast, and offers to show a video of how to remove and clean spark plugs, then the bot prefers such persona, and engages with targets in the vicinity with the selected maintenance video.

An example will now be discussed to illustrate the above principles. The following example illustrates working of the present invention in accordance with an embodiment of the present invention. A person of ordinary skilled in the art will appreciate that the present invention may be performed within any enterprise and is not limited to any particular enterprise or communication framework of the enterprise.

An enterprise has deployed a plurality of bots in a virtual world motorcycle exhibition. Human visitors in the virtual world motorcycle may use a digital avatar resembling humans to check out the virtual world motorcycle exhibition. The virtual world motorcycle exhibition may be divided in various geographical sections for different motorcycle brands. Further, the army of the bots may be deployed by a motorcycle brand ‘X’, and the bots may use persona/avatar of human beings to enter into the virtual world motorcycle exhibition.

A bot may analyze that an avatar of a twenty year old boy is looking at one of bikes of the brand ‘X’. The bot may then change its avatar of twenty year old representative of brand ‘X’, wearing t-shirt and ID card of the brand ‘X’. Thereafter, the bot may start interaction with the avatar of the twenty year old boy by uttering good words about the bike which the boy is looking observing. This action may result in failure if the avatar of the boy walks away. Thereafter, the bot may share this information in the Neural Network that it failed by trying the persona and praising strategy. Therefore, other bots in the network may stop following the strategy and may try approaching the same boy with a question “do you clean spark plug of your bike? It is necessary”. This act may result in a reply from the boy. The bot may use an NLP (natural language processor) engine to interpret the reply of the boy and may reply suitably, such as if the boy replies with “no” then the bot may say “you should start this practice to maintain your bike. I have a video on how to clean spark plugs, would you like to see the video?”

Thereafter, the bot may show a promotional video of the brand ‘X’ that teaches about cleaning of spark plugs and also promotes spark plugs of brand ‘X’. At the end of the video a clickable link may be provided that may allow the boy to purchase some products of brand ‘X’, if the boy clicked on the link then related bot will receive rewards points. The related bot may then share this successful strategy with other bots and other bots may immediately start approaching avatars of human visitors with various maintenance videos.

The exemplary systems and methods of this present invention have been described in relation to a contact center. However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description for example, various features of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A business development system of an enterprise, comprising:
a target searching module for searching and selecting a target entity from a target list;
a strategy determining module for determining a strategy to engage the target entity into a promotional activity corresponding to the enterprise; and
a strategy executing module for executing the strategy to engage the target entity into the promotional activity corresponding to the enterprise.

2. The business development system of claim 1, wherein the strategy determining module is configured to engage the target entity to purchase a product or service of the enterprise.

3. The business development system of claim 1, wherein the business development system is configured to utilize any one of a WebRTC enabled browser, a Neural Network, a JavaScript application, and a web crawler.

4. The business development system of claim 1, wherein the strategy determining module further uses pattern matching neural programming to select personas, self service experiences, locales, languages, and dialects to enhance the strategy.

5. The business development system of claim 4, wherein the strategy determining module is configured to utilize an experience database for determining the strategy and the persona.

6. The business development system of claim 1, wherein the strategy executing module is configured to interact with the target entity.

7. The business development system of claim 1, further comprising a strategy sharing module for sharing results of the strategy executed by the strategy executing module in an experience database.

8. The business development system of claim 1, wherein the strategy determining module further comprising a Natural Language Processing Engine to process inputs of the target entity.

9. The business development system of claim 1, wherein the target list includes one of a digital virtual world, a social media system, a chatting system, and Internet.

10. The business development system of claim 9, wherein the target list further includes public telephone system.

11. The business development system of claim 1, wherein the strategy executing module is further configured to establish a communication session between the target entity and a human agent from the enterprise by using WebRTC technology.

12. The business development system of claim 1, wherein the target searching module is configured to receive information corresponding to the target list from a human agent of the enterprise.

13. The business development system of claim 1, wherein the target searching module uses semantic web technology to select a target entity.

14. The business development system of claim 1, wherein the business development system is configured to perform for earning reward points.

15. A computer-implemented method for engaging a potential target in a promotional activity, the computer-implemented method comprising:
searching and selecting a potential target from a target list;
determining a strategy for engaging the potential target into the promotional activity corresponding to the enterprise; and
engaging the potential target into the promotional activity corresponding to the enterprise.

16. The computer-implemented method of claim 15, wherein determining a strategy further includes determining a persona to engage the potential target.

17. The computer-implemented method of claim 15, further comprising sharing results of the strategy in an experience database.

18. The computer-implemented method of claim 17, wherein the experience database is shared among a Neural Network of the web robots.

19. The computer-implemented method of claim 15, wherein applying the strategy includes interaction with the potential target by using a Natural Language Processing Engine to process inputs of the potential target.

20. A computer readable medium storing computer readable instructions when executed by a processor perform a method comprising:
searching and selecting a potential target from a target list;
determining a strategy for engaging the potential target into a promotional activity corresponding to the enterprise; and
engaging the potential target into the promotional activity corresponding to the enterprise.
